(19) United States
(12) Patent Application Publication
(10) Pub. No.: US 2010/0309761 A1
(43) Pub. Date: Dec. 9, 2010

(54) PRE-HEATING OF RECORDING MEDIA IN AN OPTICAL WRITING DEVICE

(76) Inventor: JOSEPH MICHAEL FREUND, Fogelsville, PA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/864,697

(22) PCT Filed: Dec. 28, 2007
(86) PCT No.: PCT/US07/89038

§ 371 Date: Jul. 27, 2010

(51) Int. Cl. G11B 19/02

(52) U.S. Cl. 369/47.19; G9B/19.001

(57) ABSTRACT

An optical writing device and methods and computer programs for writing data on an optically recordable medium are provided. One embodiment is a method for writing data on an optically recordable medium. One such method comprises: pre-heating a writing location on a recordable medium using a heat source to a temperature below a writing threshold temperature of the recordable medium; and writing on the writing location using a laser source by raising the temperature of the recording location above the writing threshold temperature.

### BACKGROUND

A typical optical writing device and the general process for writing to an optical disk is illustrated in FIG. 1. The process for recording data on a recordable optical disk involves converting an input stream of digital information with, for example, an encoder and modulator, into a drive signal for a laser source. The laser source emits an intense light beam that is directed and focused onto the surface of the recordable optical disk with illumination optics. As the surface moves under the scanning spot, energy from the intense scan spot is absorbed, and a small, localized region heats up. The surface of the recordable optical disk, under the influence of heat beyond a thermal writing threshold, changes its reflective properties and, thereby, “writes” or records data to the optical disk. Modulation of the intense light beam is synchronous with the drive signal, so a circular track of data marks is formed as the surface rotates. The scan spot is moved slightly as the surface rotates to allow another track to be written on new media during the next revolution.

This optical writing process involves a thermal process. To write data onto a spinning optical disk, the laser must be pulsed to a relatively high-power level. The time duration of the relatively high-power pulse determines the length of the data mark that is written onto the surface. Laser writing is possible because the medium is thermally sensitive (i.e., the medium exhibits a thermal threshold). This thermal threshold defines the thermal writing threshold. Below the thermal threshold, medium properties do not change significantly. Above the thermal threshold, a physical change occurs in the medium.

In practice, it can be difficult to control and/or minimize the effects of the laser on areas of the optical disk around the intended write location. It is desirable to heat only the write or writing location on the optical disk. However, as the laser pulse is focused on the write location and the optical disk is rotated, the temperature on the surface of the optical disk varies along the direction of the scan and away from the center of the pulse. This generates lines of constant temperature, which are called isotherms, on the surface of the optical disk. In operation, the isotherms spread out in the scan direction, with higher temperature isotherms closer to the center of the pulse and lower temperature isotherms further away from the center. The end of the pulse generates a wider isotherm than at the beginning of the pulse, due to the fact that heat builds up and spreads out in the direction perpendicular to the scan. This effect, referred to as thermal blooming, may be a significant problem, particularly in magneto-optic systems, if not corrected.

The higher the temperature gradient between the localized write location being heated by the laser pulse and the surrounding disk temperature, the greater will be the thermal blooming. The trend in optical recording devices is to employ higher and higher powered lasers to address customers' desire for faster and faster write speeds. The use of higher-powered lasers, however, further compounds the thermal blooming problem. Existing attempts to solve the thermal blooming problem have focused on varying the properties of the laser pulse. For example, the intensity of a given laser pulse can be timed varied to decrease at the end of the pulse duration. By decreasing the pulse intensity the thermal blooming can be reduced. Adjusting the pulse properties to control thermal blooming has its limitations. The write strategy control electronics that provide the fine adjustment to the pulse properties, are being increasingly taxed by higher writing speeds and densities. For CD writing processing, the write features are of sufficient length, that adjusting the laser pulse properties is viable. But for higher density storage processes, such as, DVD, HD-DVD and Blu-ray, adjusting the pulse properties becomes increasingly more difficult. And for next generation processes, such as, for example, magneto-optic processes, the viability of adjusting the pulse properties is further reduced. The combined disadvantage of the laser pulse adjustment limitation and the magnitude of the write laser power approaching a maximum limit, for present optical writing products, indicates a need for a new solution to the problem of thermal blooming.

### SUMMARY

Various embodiments of optical writing devices and methods and computer software for writing data on an optically recordable media are provided. One embodiment is an optical writing device comprising: an encoder and modulator adapted to convert an input data stream into a drive signal; a heat source adapted to pre-heat a writing location on a recordable medium to a temperature below a writing threshold temperature of the recordable medium; and a laser source adapted to receive the drive signal and produce a pulsed signal for writing on the writing location by heating the writing location above the writing threshold temperature.

Another embodiment is a method for writing data on an optically recordable medium. One such method comprises: pre-heating a writing location on a recordable medium using a heat source to a temperature below a writing threshold temperature of the recordable medium; and writing on the writing location using a laser source by raising the temperature of the recording location above the writing threshold temperature.

A further embodiment is a computer program embodied in a computer-readable medium for writing data on an optically recordable medium. One such computer program comprises: logic configured to operate a heat source to pre-heat a writing location on a recordable medium to a temperature below a writing threshold temperature of the recordable medium; and logic configured to operate a laser source to write on the writing location by raising the temperature of the writing location above the writing threshold temperature.

### BRIEF DESCRIPTION OF THE DRAWINGS

FIG. 1 is a combined perspective/flow diagram of an example of an existing optical writing device and an associated process for writing to the optical disk.

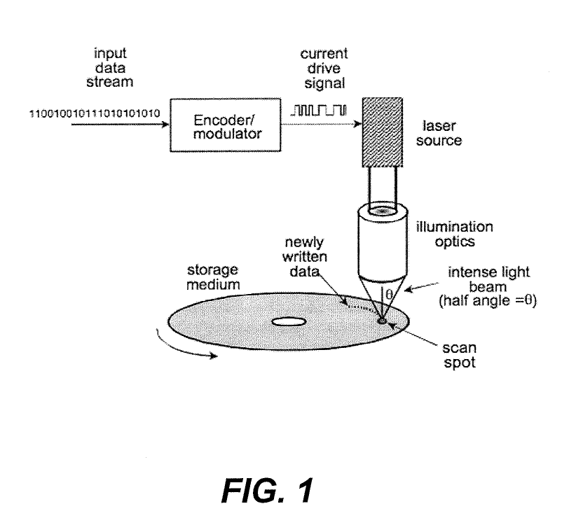

FIG. 2 is a block diagram of one of a number of possible embodiments of an optical writing device for writing data on a recordable medium by pre-heating the writing location.

FIG. 3 is a flow chart illustrating one of a number of possible embodiments of a method for writing data on an optically recordable medium by pre-heating the writing location.

FIG. 4 is a block diagram illustrating one of a number of possible embodiments of a computer system for writing data on an optically recordable medium by pre-heating the writing location.

FIG. 5 is a block diagram illustrating the architecture, operation, and/or functionality of one of a number of possible embodiments of the pre-heating system of FIG. 4.

### DETAILED DESCRIPTION

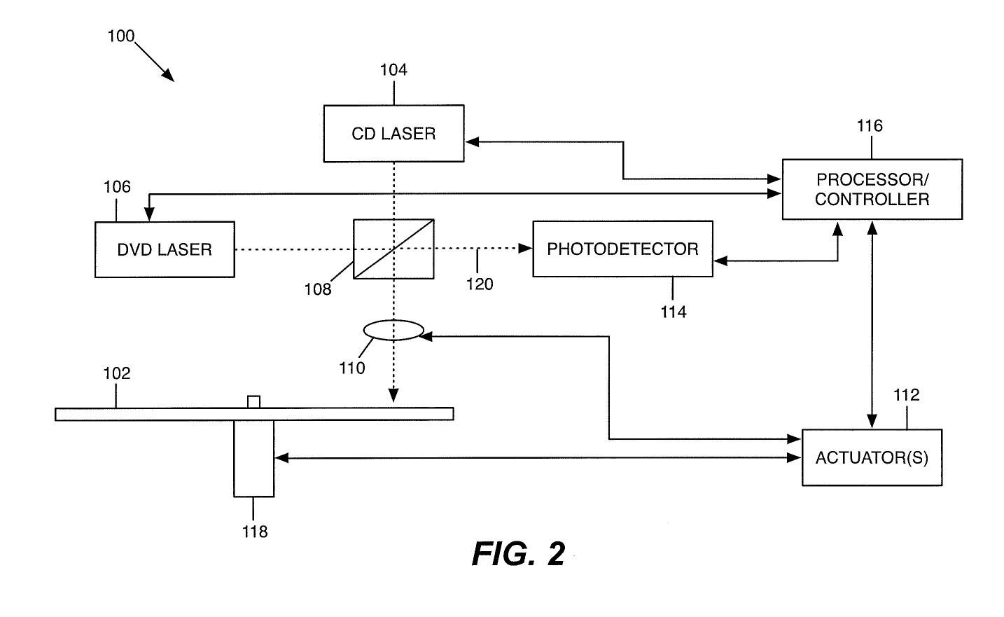

Various embodiments of optical writing devices and related methods and computer software for writing data on recordable media by pre-heating the writing location are described below with reference to FIGS. 2-5. As an introductory matter, however, the basic operation of an exemplary, non-limiting embodiment of a method for writing data by pre-heating the recordable medium will be briefly described.

The exemplary method may be implemented in any optical recording or writing device or system having a heat source and at least one laser source for recording or writing data on an optical medium. It should be appreciated that the terms “write” and “record” may be used interchangeably to refer to the process of writing data to the optical medium. In one embodiment, the method is implemented in an optical writing device having a heat source and at least one laser source. The heat source may itself comprise a laser source or, alternatively, may comprise a resistive heat source, a convection heat source, or a LED. In another embodiment, the heat source for pre-heating the optical medium comprises a CD laser and the laser source for writing the data comprises a DVD laser. One of ordinary skill in the art will appreciate that the laser sources for performing the pre-heating or the writing process may comprises any other desirable laser sources may be used (e.g., Blue or ultraviolet laser diode employed in HD-DVD and Blu-ray products, an evanescent source for next generation optical storage, flying heat optics, etc.).

As mentioned above and described in more detail below, the process of writing data to a recordable medium involves exposing data marks on the recordable medium. An input stream of digital information may be converted with an encoder and modulator into a drive signal for a laser source. The laser source emits a light beam that is directed and focused onto the surface of the thermally-sensitive recordable medium. The laser writes data to the recordable medium by changing the reflective properties of the recordable medium. Below the thermal writing threshold, the properties of the recordable medium do not change. However, when the temperature of the recordable medium reaches the thermal writing threshold, a physical change occurs, resulting in data being written to the recordable medium.

In general, the exemplary method uses a laser source to perform the write function and a heat source (or another of laser source) to pre-heat the recordable medium prior to initiating the write laser. The pre-heating process is designed to raise the temperature of the recordable medium to a desirable temperature below the critical writing threshold before engaging the laser source for the write function. The pre-heating process may be performed by heating the entire optical disk or, alternatively, by pre-heating the write locations as the recordable medium is rotated. In further embodiments, the pre-heating process and the writing process may be controlled in accordance with a drive signal to optimize the write process. In this regard, the laser source may be driven by a drive signal, and the heat source (e.g., another laser source) driven by the same signal having an adjusted amplitude. By pre-heating the recordable medium, the gradient between the write area and the surrounding disk area may be reduced. One of ordinary skill in the art will appreciate that a reduced gradient may permit the use of lower-powered laser pulses for the write function. In addition to reducing the possible effects of thermal blooming, a lower-powered laser pulse may provide a more stable optical profile which may improve the resolution of the write function. One of ordinary skill in the art will further appreciate that the freedom to use lower-powered laser pulses may also improve the reliability and lifecycle of the write lasers.

FIG. 2 illustrates an embodiment of an optical writing device 100 for writing to a recordable medium 102 by a pre-heating process. Optical writing device 100 comprises at least one heat source and at least one laser source. In the embodiment illustrated in FIG. 2, optical writing device 100 comprises two laser sources (e.g., CD laser 104 and DVD laser 106) for writing to recordable medium 102. Recordable medium 102 may comprise any suitable thermally-sensitive, recordable optical disk. For example, it should be appreciated that recordable medium 102 may comprise any of the following, or other types of optical disks: CD, DVD, HD-DVD, Blu-ray, magneto-optic, and evanescent Optical writing device 100 further comprises a beam splitter 108, illumination optics (e.g., lens 110), actuator(s) 112, a photodetector 114, a processor or controller 116, and a spindle 118 with an associated motor (not shown).

As illustrated in FIG. 2, beam splitter 108 is positioned to receive the laser signals from an operative laser source (CD laser 104 or DVD laser 106) and direct them through illumination optics 110 onto the surface of recordable medium 102. Beam splitter 108 may comprise, for example, one or more prisms, a mirrored prism, or a half-silvered mirror. When data is written to recordable medium 102, an input data stream is converted with an encoder and modulator (not shown) into a drive signal for the laser source, which emits a light beam that is directed and focused onto the surface of recordable medium 102. As mentioned above, the laser writes data to recordable medium 102 by heating the write location above the thermal writing threshold.

Photodetector 114 is used when data is being read from recordable medium 102. In the read mode, the laser source may be used at a constant output power level that does not heat the data surface beyond its thermal writing threshold. The laser source is directed through beam splitter 108 into illumination optics 110, where the beam is focused onto the surface. As the data marks to be read pass under the scan spot, the reflected light (reference numeral 120) is modulated, collected by illumination optics 110, and directed by beam splitter 108 to photodetector 114. Photodetector 114 changes light modulation into current modulation that may be amplified and decoded to produce an output data stream, which may be processed by processor/controller 116 to read the data and/or control actuator(s) 112 to control the rotation of spindle 118 or illumination optics 110.

Processor/controller 116 comprises logic configured to operate optical writing device 100 and perform read and write functions. The various functions and operations of optical writing device 100, other than the pre-heating feature used to implement the write function, will not be described. One of ordinary skill in the art will appreciate that optical writing device 100 may be implemented in various computer devices, products, or systems. In one embodiment, optical writing device 100 comprises a standalone optical recording device, such as a DVD recorder. In other embodiments, optical writing device 100 may be integrated in another computer (e.g., a personal computer, laptop, desktop, etc.).

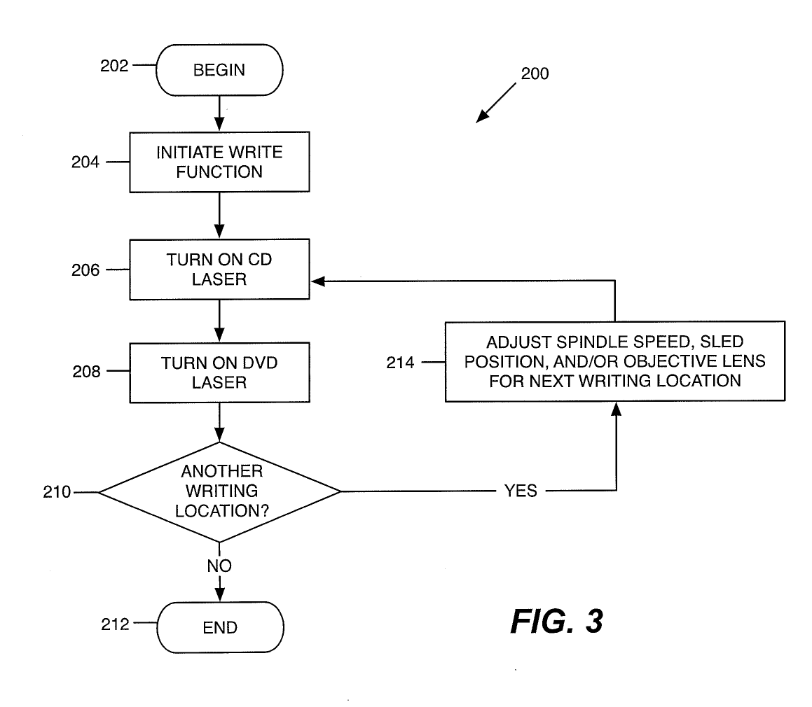

FIG. 3 illustrates one of a number of possible embodiments of a method of operating a write function by pre-heating the writing location. For the remaining description, the heating source and the laser source will be described in connection with a multi-laser embodiment, in which the heating source comprises one laser source and the writing function is performed by another laser source. At block 204, processor/control 116 initiates a write function. At block 206, one of the laser sources is turned on to pre-heat the writing location on recordable medium 102. In the example of FIG. 3, CD laser 104 is used to pre-heat the writing location, and DVD laser 106 is used to write the data to recordable medium 102. The writing location is pre-heated to a temperature below the thermal writing threshold. When the pre-heating conditions are met, CD laser 104 may be turned off and, at block 208, DVD laser 106 turned on. In alternative embodiments, DVD laser 106 may be turned on while CD laser 104 is on to prevent temperature decreases in the time period between CD laser 104 being turned off and DVD laser 106 being turned on. As mentioned above, the pre-heating may be performed simultaneously with, or prior to, the write process. The write function may be performed in a typical manner with DVD laser 106 (e.g., with a laser pulse). However, one of ordinary skill in the art will appreciate that, by pre-heating the write location prior to writing the data or heating the write location with a heat source other than the laser performing the write function, a reduced thermal gradient may be achieved and a lower-powered laser pulse may be implemented, thereby reducing thermal blooming. If additional data is to be written to recordable medium 102 (decision block 210), the spindle speed, sled position, and/or illumination optics may be adjusted (at block 214) and then the process repeated at block 206. When the write process is completed, the process ends at block 212.

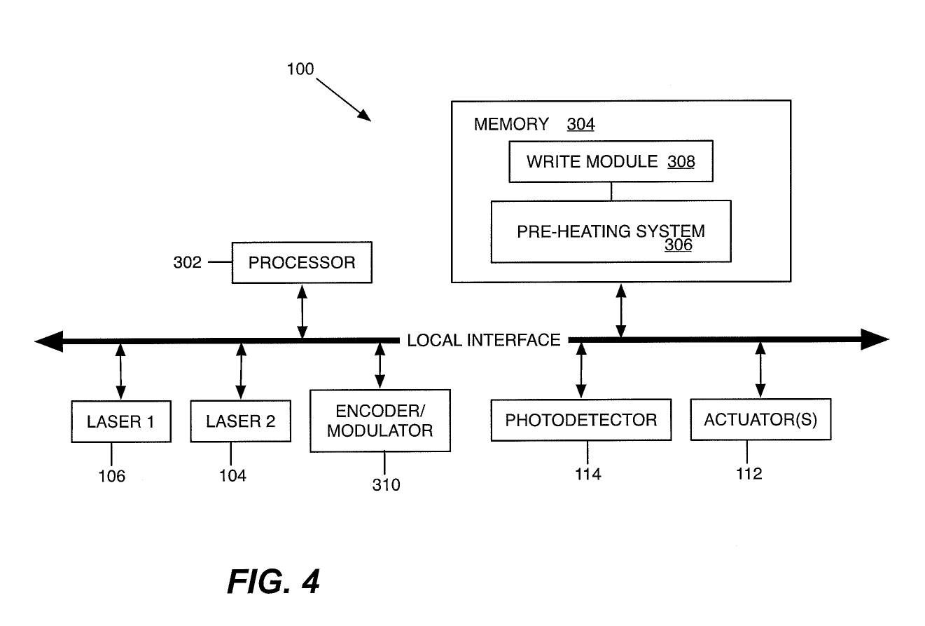

One of ordinary skill in the art will appreciate that the pre-heating process may be implemented in software, hardware, firmware, or a combination thereof. In one embodiment, as illustrated in FIG. 4, the pre-heating process may be implemented in software or firmware that is stored in a memory 304 and that is executed by a suitable instruction execution system (processor 302). As illustrated in FIG. 4, memory 304 may comprise a pre-heating system 306 that may operate in connection with other logic associated with a write module 308. It should be further appreciated that the pre-heating system may be implemented as a part of the write module or as a separate module. As further illustrated in FIG. 4, processor 302 may interface with memory 304, as well as the other components of optical writing device 100, via a local interface. In software or firmware embodiments, pre-heating system 306 may be written in any suitable computer language. It should be appreciated that existing optical writing devices may be upgraded with appropriate logic to implement pre-heating system 306. For example, the upgrade may be provided as a firmware upgrade to read-only memory located in memory 304. In hardware embodiments, pre-heating system 306 may be implemented with any or a combination of the following, or other, technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

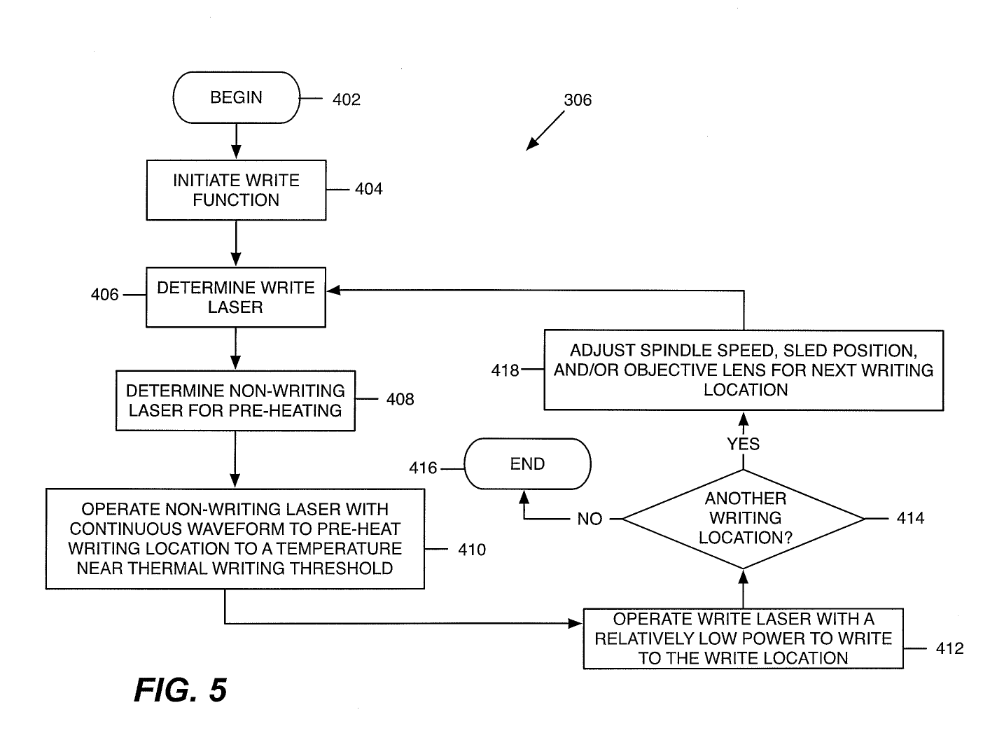

FIG. 5 illustrates the architecture, operation, and/or functionality of one of a number of possible embodiments of a pre-heating system 306. At block 404, pre-heating system 306 initiates the write function. As mentioned above, optical writing device 100 may comprise two or more laser sources. Accordingly, pre-heating system 306 may be configured with appropriate logic (block 406) to determine, or otherwise enable a user to select, the appropriate write laser for performing the write function. At block 408, the appropriate non-writing laser is determined for performing the pre-heating. At block 410, the non-writing laser may be operated with a continuous waveform to pre-heat the writing location to a temperature near the thermal writing threshold. At block 412, the write laser may be operated with a lower-powered pulse (because of the reduced temperature gradient) to write to the write location. If additional writing locations exist (decision block 414), at block 418, the spindle speed, sled position, and/or illumination optics may be adjusted for the next writing location, and flow returned to block 406, 408, or 410.

One of ordinary skill in the art will appreciate that the process descriptions or blocks related to FIGS. 3 and 5 represent modules, segments, logic or portions of code which include one or more executable instructions for implementing logical functions or steps in the process. It should be further appreciated that any logical functions may be executed out of order from that shown or discussed, including substantially concurrently or in reverse order, depending on the functionality involved, as would be understood by those reasonably skilled in the art.

Furthermore, pre-heating system 306 may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It should be noted that this disclosure has been presented with reference to one or more exemplary or described embodiments for the purpose of demonstrating the principles and concepts of the invention. The invention is not limited to these embodiments. As will be understood by persons skilled in the art, in view of the description provided herein, many variations may be made to the embodiments described herein and all such variations are within the scope of the invention.

What is claimed is:

1. An optical writing device comprising:
an encoder and modulator adapted to convert an input data stream into a drive signal;
a heat source adapted to pre-heat a writing location on a recordable medium to a temperature below a writing threshold temperature of the recordable medium; and
a laser source adapted to receive the drive signal and produce a pulsed signal for writing on the writing location by heating the writing location above the writing threshold temperature.

2. The optical writing device of claim 1, wherein the heat source comprises a further laser source.

3. The optical writing device of claim 2, wherein the further laser source comprises a CD laser and the laser source comprises a DVD laser.

4. The optical writing device of claim 1, wherein the heat source comprises at least one of a resistive heat source, a convention heat source, and an LED source.

5. The optical writing device of claim 1, wherein the heat source is driven by the drive signal.

6. The optical writing device of claim 1, further comprising a controller configured to operate the heat source and the laser source.

7. The optical writing device of claim 6, wherein the controller is configured to turn the heat source off after the laser source is turned on.

8. The optical writing device of claim 2, wherein the further laser source emits a continuous waveform to pre-heat the writing location.

9. A computer program embodied in a computer-readable medium for writing data on an optically recordable medium, the computer program comprising:
logic configured to operate a heat source to pre-heat a writing location on a recordable medium to a temperature below a writing threshold temperature of the recordable medium; and
logic configured to operate a laser source to write on the recording location by raising the temperature of the writing location above the writing threshold temperature.

10. The computer program of claim 9, wherein the heat source comprises a further laser source.

11. The computer program of claim 9, wherein the further laser comprises a first type of laser and the laser source comprises a second type of laser.

12. The computer program of claim 11, wherein the first type of laser comprises a CD laser and the second type of laser comprises a DVD laser.

13. The computer program of claim 9, wherein the heat source and the laser source are selected from a CD laser, a DVD laser, and a Blu-ray laser.

14. The computer program of claim 9, wherein the further laser source emits a continuous waveform laser signal, and the laser source emits a pulsed signal.

15. The computer program of claim 9, wherein the computer program is embodied in an encoder and modulator, and the heat source and the laser source are driven by an encoded and modulated drive signal.

16. The computer program of claim 9, wherein the heat source comprises at least one of a resistive heat source, a convection heat source, and a LED source.

17. A method for writing data on an optically recordable medium, the method comprising the steps of:
pre-heating a writing location on a recordable medium using a heat source to a temperature below a writing threshold temperature of the recordable medium; and
writing on the writing location using a laser source by raising the temperature of the writing location above the writing threshold temperature.

18. The method of claim 17, wherein the heat source comprises a further laser source, and the step of pre-heating the writing location comprises driving the further laser with a drive signal associated with the laser source.

19. The method of claim 17, wherein the heat source comprises at least one of a resistive heat source, a convection heat source, a laser source, and a LED.

20. The method of claim 17, wherein the step of pre-heating the writing location and the step of writing on the writing location are performed at least partially at the same time.
